(19) United States
(12) Patent Application Publication
(10) Pub. No.: US 2009/0059277 A1
(43) Pub. Date: Mar. 5, 2009

(54) FACSIMILE MACHINE AND METHOD FOR CONTROLLING THE SAME

(75) Inventors: Yoshinori MURATA, Kyoto-shi (JP); Masaharu FUJITA, Kyoto-shi (JP)

Correspondence Address: MURATA MACHINERY, LTD.;(MURATEC) c/o KEATING & BENNETT LLP, 1800 Alexander Bell Drive, SUITE 200, Reston, VA, 20191, US

(73) Assignee: MURATA MACHINERY, LTD., Kyoto-shi (JP)

(21) Appl. No.: 12/171,430

(22) Filed: Jul. 11, 2008

(30) Foreign Application Priority Data
Aug. 29, 2007 (JP) 2007-222367

(51) Int. Cl. G06F 3/12; H04N 1/04

(52) U.S. Cl. 358/1.15; 358/498

(57) ABSTRACT

A method for controlling a facsimile machine having a two-sided communication function includes the steps of transporting an original document to a standby position after supplying a front side of the original document to a scanning unit; transporting the original document to the standby position after reversing the original document and supplying a back side of the original document again to the scanning unit; further reversing the original document and transporting the original document to a discharge position; and sending an EOM signal to a communication destination after having the back side of the original document scanned by the scanning unit and transmitting back side image data to the communication destination.

### CROSS-REFERENCE TO RELATED APPLICATION

This application claims priority under 35 U.S.C. 119 to Japanese Patent Application No. 2007-222367, filed on Aug. 29, 2007, which application is hereby incorporated by reference in its entirety.

### BACKGROUND OF THE INVENTION

1. Field of the Invention

The present invention relates to a facsimile machine including a two-sided communication function.

2. Description of the Related Art

There is a known facsimile machine capable of transmitting and receiving image data on both sides of an original document. For example, a user operates the facsimile machine to manually scan a front side and a back side of the original document and accumulate the image data in a memory. Alternatively, after having the facsimile machine sequentially scan the image data on the front sides and accumulate the scanned data in the memory, the user may replace the original documents with the back side up, and have the machine sequentially scan the image data on the back sides and accumulate the scanned data in the memory. There is a method in which the image data on both sides accumulated in the memory is then transmitted.

There is also a known facsimile machine capable of automatically scanning both sides of an original document. The original document transported from an Auto Document Feeder (ADF) has image data on a front side scanned at a scanning unit. Then, the original document is reversed and transported again to the scanning unit, where image data on a back side is scanned. However, in the above state, after a plurality of pages of the original documents are transmitted, the original documents remain in a discharge unit with the front and back sides in a reversed state. Accordingly, after the image data on the back side is scanned, the original document is again reversed, passes through the scanning unit, and is transported to the discharge unit (hereinafter, this operation is referred to as a switch back operation). Such a scanning method is referred to as a three-pass duplex scan.

By using the three-pass duplex scan, the user has only to place the original documents on the ADF and give a transmission instruction so as to transmit the image data on both sides. However, as described above, after the back side of the original document is scanned, the switch back operation occurs to again reverse the original document. Therefore, a time lag occurs after the back side image data is transmitted and until the front side image data of a next page is transmitted.

FIG. 7 illustrates a communication protocol performed after the back side image data of a second page is transmitted. After transmitting the back side image data of the second page, a transmitting machine first sends a Multipage Signal (MPS). In response thereto, a receiving machine sends a Message Confirmation (MCF) signal.

Having received the MCF signal, the transmitting machine performs the switch back operation, for example, after recording a transmitted stamp on the back side of the original document. During the switch back operation, the transmitting machine sends fill to the receiving machine and waits until it becomes possible to transmit the front side image data of a third page.

The switch back operation may take five or six seconds, however, in a non Error-Correction-Mode (non-ECM), a transmission time of the fill is defined to be within five seconds. Consequently, a problem arises in that when the time lag until the transmission of the front side image data of the next page is prolonged, a time-out error occurs, and the communication is disconnected. Moreover, the time required for the switch back operation depends on the length of the original document in a transporting direction. In particular, the switch back operation for a long sized original document requires a substantial time, thereby increasing the possibility of a communication disconnection.

Such a problem does not arise when the facsimile machine has a large memory capacity, and when the two-sided image data scanned by the three-pass duplex scan can be temporarily accumulated in the memory. However, when the memory has a small capacity, or when the user selects real-time transmission, a time-out error occurs.

Another communication terminal machine including a conventional two-sided transmitting function sends an End Of Message (EOM) signal after transmitting front side image data. Thus, the time required for the user to reverse the original document can be secured.

### SUMMARY OF THE INVENTION

In order to overcome the problems described above, preferred embodiments of the present invention provide a technique for smoothly transmitting two-sided image data by a facsimile machine using a three-pass duplex scanning method.

In order to overcome the above-described problems, according to a preferred embodiment of the present invention, a facsimile machine including a two-sided communication function has an original document transportation unit and a communication unit. After supplying a front side of an original document to a scanning unit, the original document transportation unit transports the original document to a standby position. Then, after reversing the original document, and supplying a back side of the original document again to the scanning unit, the original document transportation unit transports the original document to the standby position, further reverses the document, and transports the document to a discharge position. After the back side of the original document is scanned by the scanning unit, and image data of the back side is transmitted to a communication destination, the communication unit sends an EOM signal to the communication destination.

According to a preferred embodiment of the present invention, after the front side of the original document is scanned by the scanning unit, and image data of the front side is transmitted to the communication destination, the communication unit sends an MPS signal to the communication destination.

According to a preferred embodiment of the present invention, the communication unit transmits the image data of the front and back sides of the original document in real time without storing the data in a memory.

According to a preferred embodiment of the present invention, after scanning the front and back sides of the original documents, the facsimile machine performs an original document reversing operation. Then, after the back side of the original document is scanned by the scanning unit, and the back side image data is transmitted to the communication destination, the EOM signal is sent. Thus, after the back side of the original document is scanned, while the facsimile machine executes the original document reversing operation, the two-sided image data can be smoothly transmitted without having the communication disconnected.

Further, according to a preferred embodiment of the present invention, after the front side of the original document is scanned by the scanning unit, and the image data of the front side is transmitted to the communication destination, the facsimile machine sends an MPS signal. Thus, after the front side image data is transmitted, the back side image data can be smoothly transmitted.

Furthermore, according to a preferred embodiment of the present invention, the facsimile machine transmits the two-sided image data in real time. Thus, even if the built-in memory has a small capacity, the two-sided image data of the original document can be smoothly transmitted.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram of a facsimile machine according to a preferred embodiment of the present invention.

FIG. 2 illustrates a transportation starting state of an original document to be scanned according to a preferred embodiment of the present invention.

FIG. 3 illustrates a state in which the original document to be scanned is transported to a standby position according to a preferred embodiment of the present invention.

FIG. 4 illustrates a communication protocol for an image on both sides of a document according to a preferred embodiment of the present invention.

FIG. 5 is a flowchart illustrating a process of transmitting the image on both sides of a document performed by the facsimile machine according to a preferred embodiment of the present invention.

FIG. 6 illustrates a communication protocol between a calling side terminal and a called side terminal according to a preferred embodiment of the present invention.

FIG. 7 illustrates a conventional communication protocol for an image on both sides.

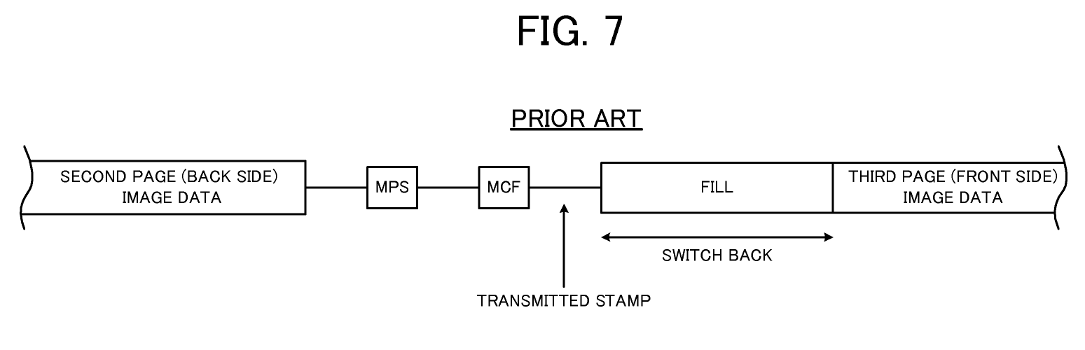

### DETAILED DESCRIPTION OF PREFERRED EMBODIMENTS

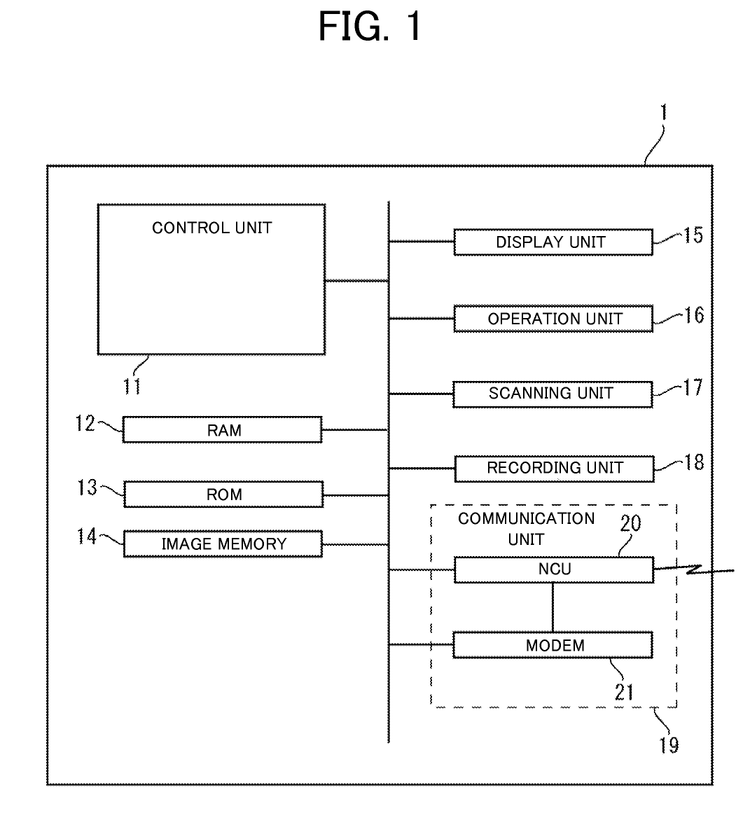

With reference to the drawings, preferred embodiments of the present invention will be described. FIG. 1 is a block diagram of a facsimile machine 1 according to a preferred embodiment of the present invention.

The facsimile machine 1 includes a two-sided communication function. The facsimile machine 1 in the present preferred embodiment may be, for example, a stand-alone facsimile machine or an operation unit of a digital Multi Function Peripheral (MFP).

A control unit 11 includes a Central Processing Unit (CPU), etc., and performs overall control of the facsimile machine 1. A Random Access Memory (RAM) 12 is used for temporarily storing data. In a Read Only Memory (ROM) 13, a program, etc., for controlling operations of the facsimile machine 1 is recorded. While using the RAM 12 as a work area, the control unit 11 executes the program stored in the ROM 13 so as to execute various functions of the facsimile machine 1 to be described below.

In an image memory 14, image data of a scanned original document is recorded. When the facsimile machine 1 executes a memory transmitting function, the image data of the scanned original document is temporarily accumulated in the image memory 14. On the other hand, when the facsimile machine 1 executes a real-time transmitting function, the image data of the scanned original document is directly transmitted to a communication destination without being accumulated in the image memory 14.

A display unit 15 displays an operational state, etc., of the facsimile machine 1. An operation unit 16 includes buttons for inputting various operation instructions to the facsimile machine 1. The display unit 15 and the operation unit 16 may be provided with a touch screen display.

A scanning unit 17 is an operation unit that scans the original document and reads the image data. In the present preferred embodiment, the scanning unit 17 includes a function of scanning only one side of the original document. Accordingly, as described later, in order to scan both sides of the original document, a three-pass duplex scan is performed. A recording unit 18 is an operation unit that prints image data received via facsimile on a recording paper.

A communication unit 19 performs communication with a machine at the communication destination via a public line or a leased line, etc. A Network Control Unit (NCU) 20 controls the lines or the like. A modem 21 performs modulation/demodulation of the image data to be transmitted/received.

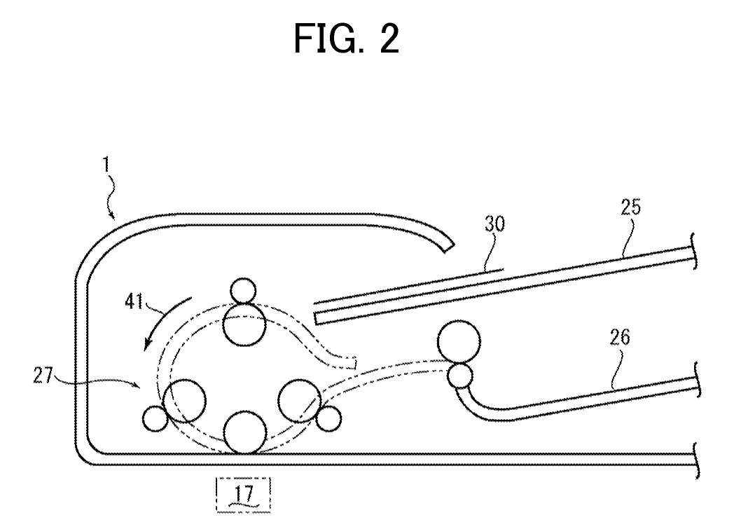

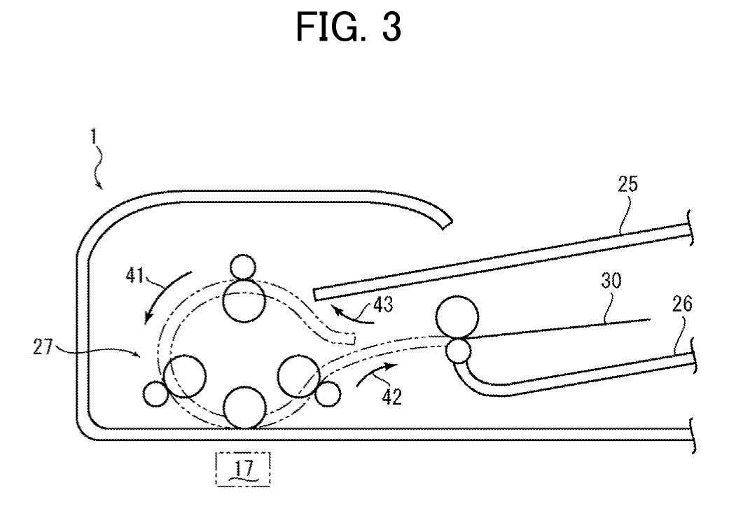

Next, with reference to FIGS. 2 and 3, a three-pass duplex scanning operation will be described. As described above, the scanning unit of the facsimile machine 1 in the present preferred embodiment can only read one side of the original document. Accordingly, in order to scan both sides of the original document, it is necessary to pass the original document through the scanning unit 17 several times.

FIG. 2 is a simplified schematic of an upper portion of the facsimile machine 1 viewed from a side thereof. An ADF 25 is mounted on the upper portion of the facsimile machine 1. A user places a plurality of original documents on the ADF 25, and thus, the plurality of original documents can be automatically scanned by the scanning unit 17.

A discharge unit 26 of the original document is provided on a lower portion side of the ADF 25. The original document scanned by the scanning unit 17 is transported to the discharge unit 26.

A transportation unit 27 supplies the original document placed on the ADF 25 to the scanning unit 17 and also transports the scanned original document to the discharge unit 26. The transportation unit 27 includes a plurality of rollers for transporting the original document and a guide plate for guiding the original document, or the like.

As illustrated in FIG. 2, a first sheet of the original documents 30 placed on the ADF 25 is first transported to the transportation unit 27. For convenience, one sheet of the original document 30 is illustrated in the drawing, however, a plurality of original documents are placed on the ADF 25, and as illustrated in FIG. 2, one of the original documents 30 is transported to the transportation unit 27.

After being transported to the transportation unit 27 from the ADF 25, the original document 30 is transported in a direction of arrow 41, and passes through an upper portion of the scanning unit 17. At this time, a front side of the original document 30 is scanned by the scanning unit 17. The scanned original document is then transported in a direction of arrow 42, and as illustrated in FIG. 3, kept at a standby position.

Then, the original document 30 is transported from the standby position in a direction of arrow 43 in FIG. 3. The original document 30 is further transported in the direction of arrow 41, and passes through the upper portion of the scanning unit 17. At this time, the original document 30 is reversed, and a back side of the original document 30 is scanned by the scanning unit 17. The scanned original document 30 is again transported in the direction of arrow 42, and as illustrated in FIG. 3, kept at the standby position.

If the original document 30 is directly discharged to the discharge unit 26 from the above state, by having the both sides of the plurality of original documents scanned, the original documents will remain in a reversed state. In order to prevent such a state, a switch back operation is performed next. That is, the original document 30 is again transported in the direction of arrows 43 and 41, passes through the upper portion of the scanning unit 17, and is transported in the direction of arrow 42 to the discharge unit 26. By such a switch back operation, even when the duplex scanning of the plurality of original documents is performed, the original documents are not reversed. Thus, both sides of one sheet of the original document are scanned by the three-pass duplex scan including the three transportations of the original document: the transportation of the original document for scanning the front side; the transportation of the original document for scanning the back side; and the transportation of the original document for the switch back operation.

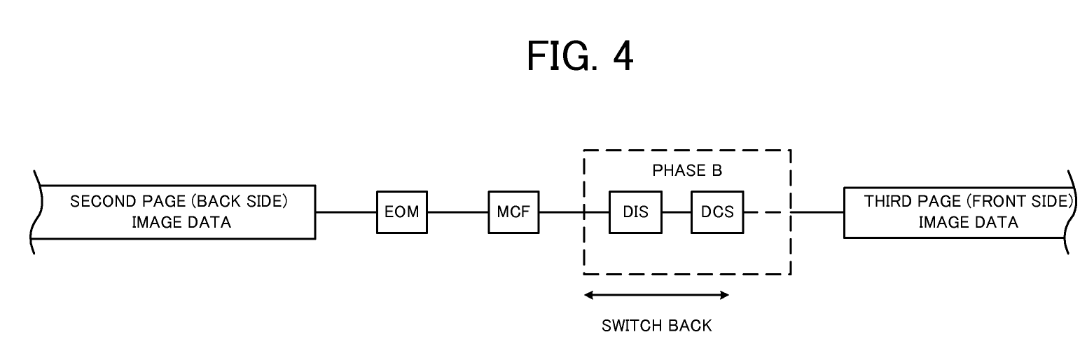

Next, a description will be made of a communication protocol carried out after the facsimile machine 1 in the present preferred embodiment transmits the back side image data of the original document. More specifically, the description will be made of the communication protocol carried out when the facsimile machine 1 performs the three-pass duplex scan and transmits the two-sided image data in real time. FIG. 4 illustrates the communication protocol executed after the back side image data of a second page is transmitted and until the front side image data of a third page is transmitted.

It is assumed that the user operates the operation unit 16 and instructs the duplex real-time transmission of the original document. That is, the image data scanned by the scanning unit 17 is directly transmitted in real time to the communication destination without being accumulated in the image memory 14.

After the back side image data of the second page is scanned by the scanning unit 17, the facsimile machine 1 transmits the back side image data of the second page to the communication destination. Then, the facsimile machine 1 sends an EOM signal to the communication destination. Having received the EOM signal, the communication destination sends an MCF signal in response.

Thus, a communication protocol of a mode changing protocol (phase B) is started between the facsimile machine 1 and the communication destination. More specifically, the communication destination sends a Digital Identification Signal (DIS), and in response thereto, the facsimile machine 1 sends a Digital Command Signal (DCS) to the communication destination. Further, a training signal, etc., is transmitted/received.

Accordingly, when performing the real-time transmission using the three-pass duplex scan, after transmitting the back side image data, the facsimile machine 1 in the present preferred embodiment once changes the communication protocol with the communication destination to the mode changing protocol (phase B) by sending the EOM signal. Then, while executing the mode changing protocol, the facsimile machine 1 completes the switch back operation. As illustrated in FIG. 4, when the mode changing protocol is ended, the transmission of the front side image data of the third page is started.

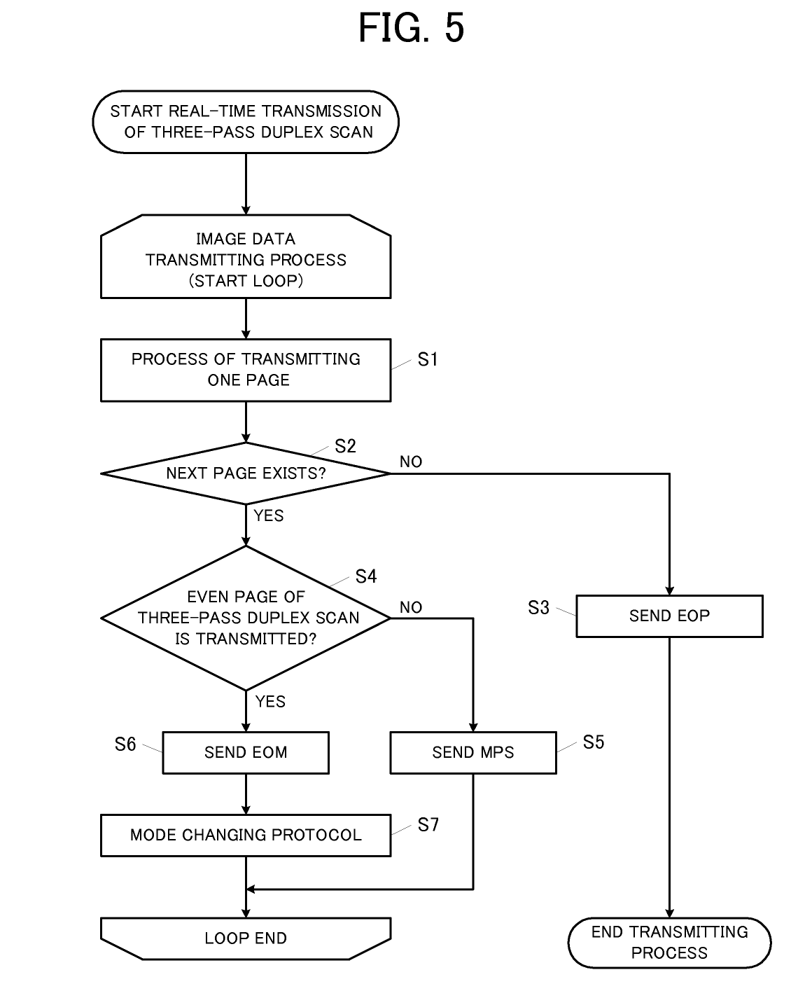

FIG. 5 is a flowchart of the real-time transmission at the time of a three-pass duplex scan performed by the facsimile machine 1 of the present preferred embodiment. The user places the plurality of original documents on the ADF 25. Then, the user operates the operation unit 16 to designate the facsimile number of the communication destination and instruct the real-time transmission of the two-sided original document. Accordingly, the process illustrated in FIG. 5 is started.

First, the facsimile machine 1 starts a loop process of an image data transmitting process. Then, the image data of a first page is transmitted (step S1). More specifically, the front side image data of a first sheet of an original document is transmitted to the communication destination.

Then, the facsimile machine 1 determines whether or not the image data of a next page exists (step S2). When the image data of the next page does not exist (“NO” in step S2), the facsimile machine 1 sends an End Of Procedure (EOP) signal (step S3), and ends the transmitting process.

When the image data of the next page exists (“YES” in step S2), the facsimile machine 1 determines whether or not the image data of the page transmitted in step S1 corresponds to an even page of the three-pass duplex scan (step S4). The even page of the three-pass duplex scan corresponds to the back side of the original document.

When the image data of the page transmitted in step S1 is not the even page of the three-pass duplex scan (“NO” in step S4), in other words, when it is immediately after the front side image data of the original document is transmitted, an MPS signal is sent (step S5). After sending the MPS signal, the facsimile machine 1 returns to step S1, and transmits the back side image data of the same original document. Thus, after the front side image data of the original document is transmitted, the original document is transported in the direction of arrows 43, 41 in FIG. 3, and the back side of the original document is immediately scanned by the scanning unit 17. Accordingly, by sending the MPS signal, the facsimile machine 1 can immediately transmit the image data of the next page.

When the image data of the page transmitted in step S1 is the even page of the three-pass duplex scan (“YES” in step S4), in other words, when it is immediately after the back side image data of the original document is transmitted, the EOM signal is sent (step S6), and the protocol is changed to the mode changing protocol (step S7). While executing the mode changing protocol, the facsimile machine 1 completes the switch back operation of the original document that has been transmitted. Then, the process returns to step S1, where the front side image data of the next original document is transmitted. Thus, after the back side image data of the original document is transmitted, by sending the EOM signal, the facsimile machine 1 can secure the time for the switch back operation and smoothly execute the communication protocol.

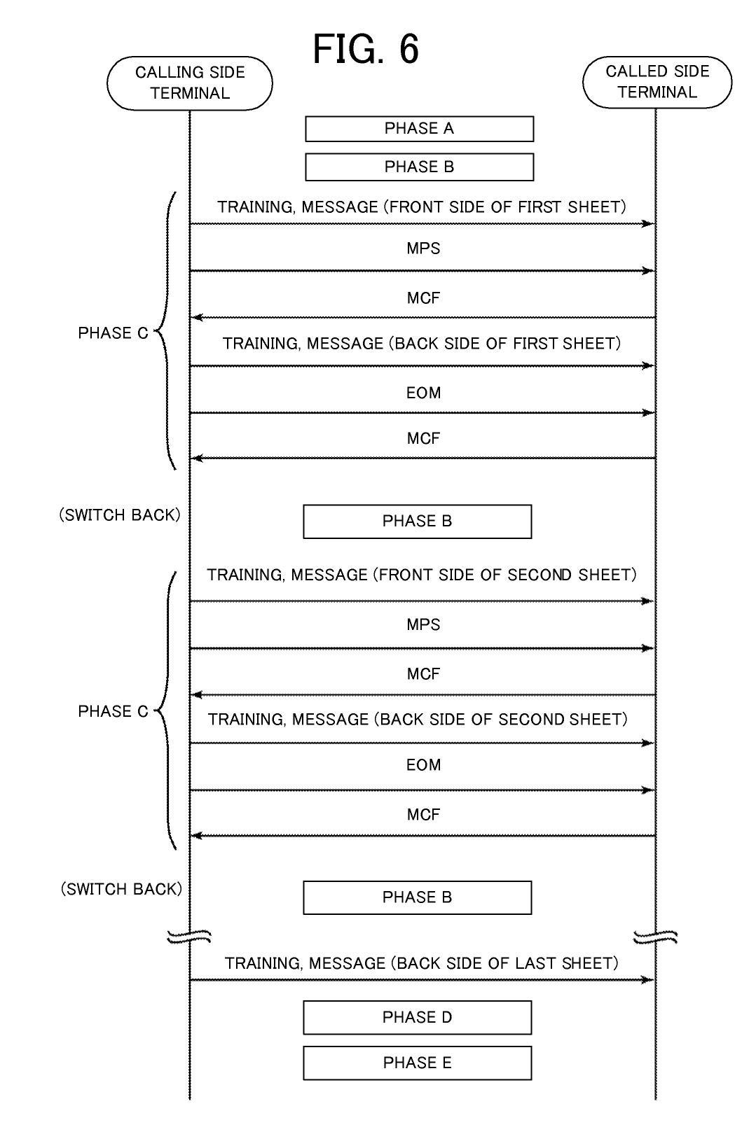

FIG. 6 is a sequence diagram focusing on a signal transmitted/received between a calling side terminal and a called side terminal in the real-time transmission of the three-pass duplex scan. The calling side terminal is a communication terminal on a side transmitting the image data, and the called side terminal is a communication terminal on a side receiving the image data. That is, the calling side terminal corresponds to the facsimile machine 1 of the present preferred embodiment that executes the process of FIG. 5.

First, a phase A in which calling setting is performed is executed between the calling side terminal and the called side terminal. More specifically, the calling side terminal sends a Calling Tone (CNG) signal, which is a calling signal, and in response thereto, the called side terminal sends a Called Station Identification (CED) signal.

Then, the phase B, which is a pre-protocol (the mode changing protocol), is executed. In the phase B, the DIS signal is sent from the called side terminal to the calling side terminal, and a receiving function of the called side terminal is notified. In response, the calling side terminal sends the DCS signal to the called side terminal, and the determined communication mode is notified. Here, the calling side terminal notifies by the DCS signal that the two-sided communication will be performed in an alternating mode. The alternating mode is a two-sided communication mode that alternately transmits the front side image data and the back side image data. Further, in the phase B, the training signal is sent from the calling side terminal to the called side terminal. When reception preparation is completed, the called side terminal sends a Confirmation To Receive (CFR) signal to the calling side terminal.

When the protocol of the phase B is completed, the actual transmission and reception of the image data is started in a phase C. First, the front side image data of the first page is transmitted from the calling side terminal. Then, the calling side terminal sends the MPS signal, and notifies that the image data of a following page exists. In response, the called side terminal sends the MCF signal to the calling side terminal.

Then, the calling side terminal transmits the back side image data of the first sheet to the called side terminal. Then, the calling side terminal sends the EOM signal. Having received the EOM signal, the called side terminal sends the MCF signal in response. Thus, the calling side terminal and the called side terminal change again to the mode changing protocol of phase B. While the mode changing protocol is executed, the switch back operation of the first sheet of the original document is performed, and the first sheet of the original document is discharged to the discharge unit 26. Then, the second sheet of the original document is supplied from the ADF 25 to the transportation unit 27, and the front side image data of the second sheet of the original document is scanned by the scanning unit 17.

Then, the calling side terminal and the called side terminal change to phase C, in which the transmission and reception of the second sheet of the original document are performed. Similarly to the case of the first sheet of the original document, after the front side image data is transmitted, the MPS signal and the MCF signal are exchanged. After the back side image data is transmitted, the calling side terminal sends the EOM signal, and changes to the phase B. By repeating this protocol, the image data on both sides can be smoothly transmitted in real time without causing any problem in the communication protocol after the two-sided image data is transmitted.

After the back side image data of a last original document is transmitted, the communication protocol in phase D and phase E is executed, and the communication is completed.

Thus, by using the facsimile machine 1 of the present preferred embodiment, even when transmitting in real time the original document scanned by the three-pass duplex scan, the facsimile machine 1 can smoothly transmit and receive the data on both sides of the original document without causing any problem in the communication protocol.

Accordingly, even when the capacity of the image memory 14 of the facsimile machine 1 is small, and when the image data of both sides of the plurality of original documents cannot be accumulated in the image memory 14, the original documents can be scanned by the three-pass duplex scan and transmitted. Thus, the user is not required to manually reverse the original documents, and thereby increasing the convenience.

Moreover, when the capacity of the image memory 14 is large, and the image data on both sides of the plurality of original documents can be accumulated in the image memory 14, the processing method of the present preferred embodiment is effective. The user can freely select the real-time transmission or memory transmission, and transmit the two-sided original documents.

In the above-described preferred embodiments, the original document 30 having the back side thereof scanned (refer to FIGS. 2 and 3) is again transported in the direction of arrows 43, 41, passes through the upper portion of the scanning unit 17, and thus the switch back operation is performed. However, the above switch back operation is only one example. The communication protocol of the various preferred embodiments can be effective when the switch back operation is performed with other preferred embodiments. For example, the original document having the back side thereof scanned may be reversed without passing through the scanning unit, and may be discharged to the discharge unit 26. In other words, the communication protocol of the various preferred embodiments can be applied to a general facsimile machine in which a reversing operation is again performed on an original document having a back side thereof scanned, and a front side image data of a next page is scanned after the reversing operation.

The above-described signals such as the EOM and MPS signals are defined by International Telecommunication Union Telecommunication (ITU-T) 30 Recommendation.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. A facsimile machine having a two-sided communication function comprising:
an original document transportation unit arranged to transport an original document to a standby position after supplying a front side of the original document to a scanning unit, reverse the original document, supply a back side of the original document again to the scanning unit, transport the original document to the standby position, further reverse the original document, and transport the original document to a discharge position; and
a communication unit arranged to send an end of message signal to a communication destination after having the back side of the original document scanned by the scanning unit and transmitting back side image data to the communication destination.

2. The facsimile machine according to claim 1, wherein the communication unit is arranged to send a multi-page signal to the communication destination after having the front side of the original document scanned by the scanning unit and transmitting front side image data to the communication destination.

3. The facsimile machine according to claim 1, wherein the communication unit is arranged to transmit the front side image data and the back side image data of the original document in real time without accumulating the data in a memory.

4. A method for controlling a facsimile machine having a two-sided communication function, comprising the steps of:
transporting an original document to a standby position after supplying a front side of the original document to a scanning unit;
transporting the original document to the standby position after reversing the original document and supplying a back side of the original document again to the scanning unit;
further reversing the original document and transporting the original document to a discharge position; and
sending an end of message signal to a communication destination after having the back side of the original document scanned by the scanning unit and transmitting back side image data to the communication destination.

5. The method for controlling the facsimile machine according to claim 4, further comprising the step of sending an MPS signal to the communication destination after having the front side of the original document scanned by the scanning unit and transmitting front side image data to the communication destination.

6. The method for controlling the facsimile machine according to claim 4, further comprising the step of transmitting the front side image data and the back side image data of the original document in real time without accumulating the data in a memory.

7. A digital storage medium having electronically readable control data stored thereon and when run on a programmable computing device performs the method of claim 4.
